(19) United States
(12) Patent Application Publication
(10) Pub. No.: US 2026/0237244 A1
(43) Pub. Date: Aug. 13, 2026

(54) INFORMATION PROCESSING APPARATUS, INFORMATION PROCESSING METHOD AND RECORDING MEDIUM

(71) Applicant: NEC Corporation, Tokyo (JP)

(72) Inventors: Hirokazu HAMADA, Tokyo (JP); Kensaku SATO, Tokyo (JP); Akito SUGA, Tokyo (JP)

(73) Assignee: NEC Corporation, Tokyo (JP)

(21) Appl. No.: 19/148,073

(22) PCT Filed: Mar. 10, 2023
(86) PCT No.: PCT/JP2023/009326

§ 371 Date: Jul. 15, 2025

(51) Int. Cl. G06V 40/50; G06F 21/32; G06V 40/16

(52) U.S. Cl. CPC G06V 40/50; G06F 21/32; G06V 40/172

(57) ABSTRACT

An information processing apparatus comprises an image acquiring means for acquiring an image including a face authentication area through which an authenticated person passes, a face authentication means for performing face authentication of the authenticated person based on the image, and a determining means for determining whether or not the authenticated person is a child by acquiring age information related to the authenticated person, which is linked to a registered person identified by the face authentication means performing the face authentication.

### TECHNICAL FIELD

This discloser relates to technical fields of an information processing apparatus, an information processing method and a recording medium.

### BACKGROUND

As an apparatus of this type, an apparatus performing face authentication on a person in an authentication region based on an image generated by imaging the authentication region around a ticket gate machine equipped in a ticket gate of a railway station and open/close controlling a door of the ticket gate machine based on a result of face authentication is proposed, for example (see Patent Literature 1). Furthermore, Patent Literatures 2 to 4 are cited as prior art documents related to this disclosure.

### CITATION LIST

### Patent Literature

Patent Literature 1: Japanese Patent Laid-Open No. 2021-149257
Patent Literature 2: Japanese Patent Laid-Open No. 2022-010919
Patent Literature 3: International Patent Publication No. 2021/065488
Patent Literature 4: International Patent Publication No. 2020/203744

### SUMMARY

### Technical Problem

This disclosure is to provide an information processing apparatus, an information processing method and a recording medium aiming to improve techniques in the prior art documents.

### Solution to Problem

One aspect of an information processing apparatus is provided with: an image acquiring means for acquiring an image including a face authentication area through which an authenticated person passes; a face authentication means for performing face authentication of the authenticated person based on the image; and a determining means for determining whether or not the authenticated person is a child by acquiring age information related to the authenticated person, which is linked to a registered person identified by the face authentication means performing the face authentication.

One aspect of an information processing method includes: acquiring an image including a face authentication area through which an authenticated person passes; performing face authentication of the authenticated person based on the image; and determining whether or not the authenticated person is a child by acquiring age information related to the authenticated person, which is linked to a registered person identified by performing the face authentication.

One aspect of a recording medium is a recording medium on which a computer program is recorded, wherein the computer program causes a computer to execute an information processing method including: acquiring an image including a face authentication area through which an authenticated person passes; performing face authentication of the authenticated person based on the image; and determining whether or not the authenticated person is a child by acquiring age information related to the authenticated person, which is linked to a registered person identified by performing the face authentication.

### BRIEF EXPLANATION OF DRAWINGS

FIG. 1 is a diagram showing an overview of a ticket gate system of a first embodiment.

FIG. 2 is a diagram showing an example of a face authentication area.

FIG. 3 is a diagram showing an example of a face information database.

FIG. 4 is a flowchart showing operation of an information processing apparatus of the first embodiment.

FIG. 5 is a block diagram showing configuration of an information processing apparatus of a first modified example and a second modified example of the first embodiment.

FIG. 6 is a block diagram showing an information processing apparatus of a third modified example of the first embodiment.

FIG. 7 is a diagram showing an overview of a ticket gate system of a second embodiment.

FIG. 8 is a block diagram showing configuration of an information processing apparatus of the second embodiment.

FIG. 9 is a diagram for explaining a process of tracking a person.

FIG. 10 is a diagram showing an example of an ID correspondence table.

### DESCRIPTION OF EMBODIMENTS

### First Embodiment

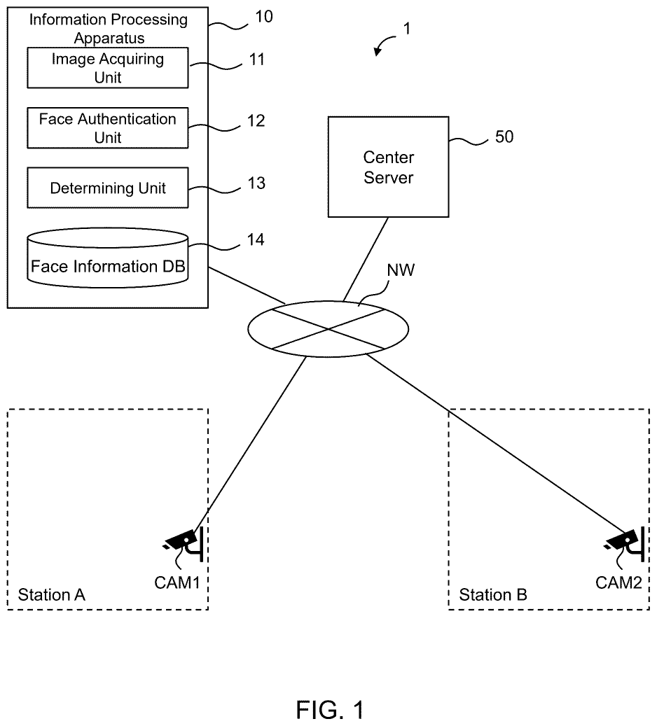

A first embodiment of an information processing apparatus, an information processing method, and a recording medium will be described with reference to FIGS. 1 to 4. Hereinafter, the first embodiment of the information processing apparatus, the information processing method, and the recording medium will describe by using an information processing apparatus 10 provided in a ticket gate system 1.

### Overview of the Ticket Gate System

An overview of the ticket gate system 1 of the first embodiment will be described with reference to FIG. 1. In FIG. 1, the ticket gate system 1 includes an information processing apparatus 10 and a center server 50. The ticket gate system 1 includes a camera CAM 1 installed at a railway station A and a camera CAM 2 installed at a railway station B. The information processing apparatus 10, the center server 50, and the cameras CAM 1 and CAM 2 are connected via a network NW. Incidentally, hereinafter, the railway station will be referred to as “station” as appropriate.

Incidentally, other cameras may be installed at the station A in addition to the camera CAM1. In other words, two or more cameras may be installed at the station A. Similarly, other cameras may be installed at the station B in addition to the camera CAM2. In other words, two or more cameras may be installed at the station B. The network NW may be a wide area network such as the Internet.

The information processing apparatus 10 may perform face authentication based on the images captured by the camera CAM1 and identify persons entering the station A and persons exiting from the station A. The information processing apparatus 10 may perform face authentication based on the images captured by the camera CAM2 and identify persons entering the station B and persons exiting from the station B.

For example, it is assumed that a person P corresponding to a registered person R enters the station A. Then, the person P travels to the station B using a railway. Then, the person P exits from the station B.

When the person P enters the station A, the information processing apparatus 10 may perform face authentication based on images captured by the camera CAM1 to identify the person P as the registered person R. The information processing apparatus 10 may link the identification information indicating the registered person R with the information indicating that the person P has entered the station A and transmit the linked information to the center server 50. The center server 50 may register that the registered person R has entered the station A. At least one of the information processing apparatus 10 and the center server 50 may transmit information indicating that the person P who is the registered person R has entered the station A to a terminal apparatus (e.g., a smartphone) held by the person P.

When the person P exits from the station B, the information processing apparatus 10 may perform face authentication based on the image captured by the camera CAM2 to identify the person P as registered person R. The information processing apparatus 10 may link identification information indicating the registered person R with information indicating that the person P has exited from the station B and transmit the linked information to the center server 50. The center server 50 may register that the registered person R has exited from the station B. At least one of the information processing apparatus 10 and the center server 50 may transmit information indicating that the person P who is the registered person R has exited from the station B to the terminal apparatus possessed by the person P.

As a result, the center server 50 may register that the registered person R entered the station A and exited from the station B. The center server 50 may calculate the railway usage fee (e.g., fare) from the station A to the station B. The center server 50 may settle the calculated railway usage fee using the payment information related to the registered person R. The center server 50 may transmit information indicating the railway usage fee to the terminal apparatus held by the person P who is the registered person R. The settlement information may be at least one of credit card information, debit card information, prepaid card information, IC (Integrated Circuit) card information, and account information, for example.

As described above, the information processing apparatus 10 is an apparatus for detecting the entry and exit of persons in stead of a ticket gate apparatus (e.g., an automatic ticket gate) that detects the entry and exit of persons using at least one of, for example, magnetic tickets, IC tickets, and mobile tickets.

### Information Processing Apparatus

In FIG. 1, the information processing apparatus 10 includes an image acquiring unit 11, a face authentication unit 12, a determining unit 13, and a face information database 14 (hereinafter referred to as “face information DB 14” as appropriate). The image acquiring unit 11 acquires images taken by each of cameras CAM1 and CAM2.

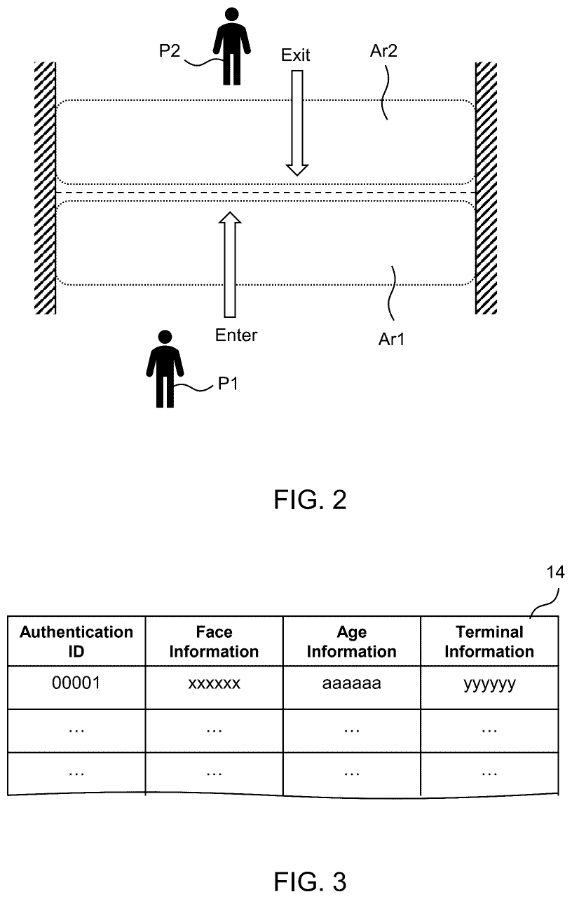

Here, the ticket gate area of a station (e.g., at least one of stations A and B) will be described with reference to FIG. 2. In FIG. 2, the broken lines indicate the boundary between the station premises and the station exterior. In FIG. 2, the area above the broken lines corresponds to the station premises. In FIG. 2, the area below the broken lines corresponds to the station exterior. The broken lines are shown only for convenience of description. The lines corresponding to the broken lines in FIG. 2 need not be drawn in the actual ticket gate area of the station. A gate apparatus having members (e.g., flaps) that open and close in accordance with the results of face authentication may be provided at positions corresponding to the broken lines.

In FIG. 2, face authentication areas Ar1 and Ar2 may be set in the vicinity of the broken lines (i.e., the boundary between the station premises and the station exterior). Face authentication areas Ar1 and Ar2 are virtual areas. A person entering the station (e.g., the person P1 in FIG. 2) enters the station by passing through the face authentication area Ar1 from outside the station premises toward the station premises and crossing the broken line. A person exiting from the station (e.g., the person P2 in FIG. 2) exits from the station by passing through the face authentication area Ar2 from inside the station premises toward the station premises and crossing the broken line.

The shapes, positions, and ranges of the face authentication areas Ar1 and Ar2 shown in FIG. 2 are examples and are not limited to these. The face authentication areas (e.g., at least one of the face authentication areas Ar1 and Ar2) may be set appropriately in consideration of, for example, the structure of the station building, traffic rules, and the number of passengers boarding and alighting.

The camera CAM1 may image the face authentication area set in the ticket gate area of the station A (i.e., the face authentication area corresponding to at least one of face authentication areas Ar1 and Ar2 in FIG. 2). Incidentally, when other cameras are installed in the ticket gate area of the station A in addition to the camera CAM1, the camera CAM1 may image at least a part of the above face authentication area.

The image acquiring unit 11 acquires an image including at least a part of the face authentication area set in the ticket gate area of the station A, which is captured by the camera CAM1. Incidentally, the image captured by the camera CAM1 may be provided with, for example, time information (e.g., a time stamp) indicating the capture time and position information indicating the position of the camera CAM1. Incidentally, the image captured by the camera CAM1 may include information identifying the ticket gate area of the station A instead of or in addition to the position information indicating the position of the camera CAM1.

The camera CAM2 may capture an image of a face authentication area set in the ticket gate area of the station B (i.e., a face authentication area corresponding to at least one of face authentication areas Ar1 and Ar2 in FIG. 2). When other cameras are installed in the ticket gate area of the station B in addition to the camera CAM2, the camera CAM2 may capture at least a part of the above face authentication area.

The image acquiring unit 11 acquires images containing at least a part of the face authentication area set in the ticket gate area of the station B, which are captured by the camera CAM2. Incidentally, the images captured by the camera CAM2 may be provided with, for example, time information (e.g., a time stamp) indicating the capture time and position information indicating the position of the camera CAM2. Incidentally, the image captured by the camera CAM2 may include information identifying the ticket gate area of the station B instead of or in addition to the position information indicating the position of the camera CAM2.

Incidentally, the station (e.g., at least one of the station A and the station B) may have two or more ticket gate areas. In this case, two or more cameras may be installed at the station to capture the face authentication areas of the two or more ticket gate areas.

The face authentication unit 12 of the information processing apparatus 10 performs face authentication based on the image acquired by the image acquiring unit 11. Various existing methods of face authentication, such as two-dimensional (2D) authentication and three-dimensional (3D) authentication, may be used. An example of the face authentication process is described below.

The face authentication unit 12 may detect the faces of a person (hereinafter referred to as “authenticated person”) included in the images. The face authentication unit 12 may calculate face feature quantities indicating the feature of the detected face. The face authentication unit 12 may identify the registered person corresponding to the authenticated person using the calculated face feature quantity and the face information DB 14.

Here, the face information DB 14 will be explained with reference to FIG. 3. The face information DB 14 stores information related to persons who wish to use the ticket gate system 1. A person, whose information is registered in the face information DB 14, among the persons, who wish to use the ticket gate system 1, corresponds to the above-mentioned “registered person”. The face information DB 14 stores authentication IDs as identification information for identifying a plurality of registered persons. The information of each of the plurality of registered persons is registered in the face information DB 14 linked to the authentication ID. The authentication ID may be an example of the “identification information indicating the registered person R” described above.

As shown in FIG. 3, for a registered person, face information, age information, and terminal information may be linked to the authentication ID and registered in the face information DB 14. As shown in FIG. 3, for a registered person, face information, payment information, and terminal information may be linked to an authentication ID and registered in a face information DB 14. The face information may be, for example, information (e.g., a file name) for identifying feature quantities that indicate the features of a face of the registered person. Alternatively, the face information may be, for example, information (e.g., a file name) for identifying a face image that includes the face of the registered person. The age information may be information indicating the date of birth of a registered person. Alternatively, the age information may be information indicating the current age of the registered person. The terminal information may be information (e.g., at least one of a telephone number and an email address) for identifying a terminal apparatus (e.g., a smartphone) possessed by a registered person.

A face image including a face of a registered person may be generated, for example, by capturing the face of the registered person with a camera at the time of registration. The face image may be obtained from a recording medium showing the face of the registered person. The “recording medium showing the face of the registered person” may be at least one of a recording medium on which a face image including the face of the registered person is printed, and a recording medium having an electronic component (e.g., an IC chip) that stores a face image including the face of the registered person. A My Number Card and a driver's license are cited as examples of such recording media.

The face authentication unit 12 may calculate a matching score from the calculated face feature quantity (i.e., the face feature quantity related to the face of the authenticated person) and the face feature quantity based on the face information of a registered person registered in the face information DB 14. When the calculated matching score is greater than a predetermined threshold, the face authentication unit 12 may determine that the registered person is the registered person corresponding to the authenticated person. When the calculated matching score is smaller than a predetermined threshold value, the face authentication unit 12 may calculate a matching score from the calculated face feature quantity and the face feature quantity based on the face information of other registered persons registered in the face information DB 14. When the calculated matching score and the predetermined threshold value are “equal,” either case may be included in the treatment.

The determining unit 13 of the information processing apparatus 10 acquires age information linked to the registered person corresponding to the authenticated person, which is identified by the face authentication unit 12 performing face authentication. The determining unit 13 determines whether or not the authenticated person is a child based on the acquired age information. Here, “child” means a person to whom a “child fare” for railway usage fees (e.g., transportation fares) is applicable. The “Child” may include, for example, persons under the age of 12 and persons aged 12 who have not yet entered middle school. For example, if the current date is before April 1, the determining unit 13 may determine that a person aged 12 is a person aged 12 who has not yet entered middle school.

When the age information indicates the date of birth of the registered person corresponding to the authenticated person, the determining unit 13 may calculate the current age of the authenticated person from the date of birth indicated by the age information and the current date. The determining unit 13 may determine whether or not the authenticated person is a child based on the calculated age. When the age information indicates the current age of the registered person, the determining unit 13 may determine whether the authenticated person is a child based on the age indicated by the age information.

When the authentication unit 13 determines that the authenticated person is a child, the information processing apparatus 10 may link the authentication ID of the registered person corresponding to the authenticated person, information indicating that the authenticated person is a child, and information indicating that the authenticated person has entered or exited the station, and send the linked information to the center server 50. The center server 50 may register that the registered person corresponding to the authentication ID sent from the information processing apparatus 10 is a child.

When the determining unit 13 determines that the authenticated person is not a child (i.e., the authenticated person is an adult), the information processing device 10 may link the authentication ID related to the registered person corresponding to the authenticated person with information indicating that the authenticated person has entered or exited the station, and transmit the linked information to the center server 50. The center server 50 may register that the registered person corresponding to the authentication ID transmitted from the information processing apparatus 10 is an adult. The center server 50 need not register that the registered person is an adult. In this case, the center server 50 may treat registered persons, who are not registered as children, as adults.

Incidentally, the information processing apparatus 10 may not transmit information indicating that the authenticated person is an adult to the center server 50. The information processing apparatus 10 may transmit information indicating that the authenticated person is an adult to the center server 50. The “child” means a person to whom a “child fare” for railway usage fees (e.g., transportation fares) applies. The “adult” may include persons aged 13 or older, as well as persons aged 12 who have entered middle school. For example, the determining unit 13 may determine that a person aged 12 is a person who has entered middle school if the current date is April 1 or later.

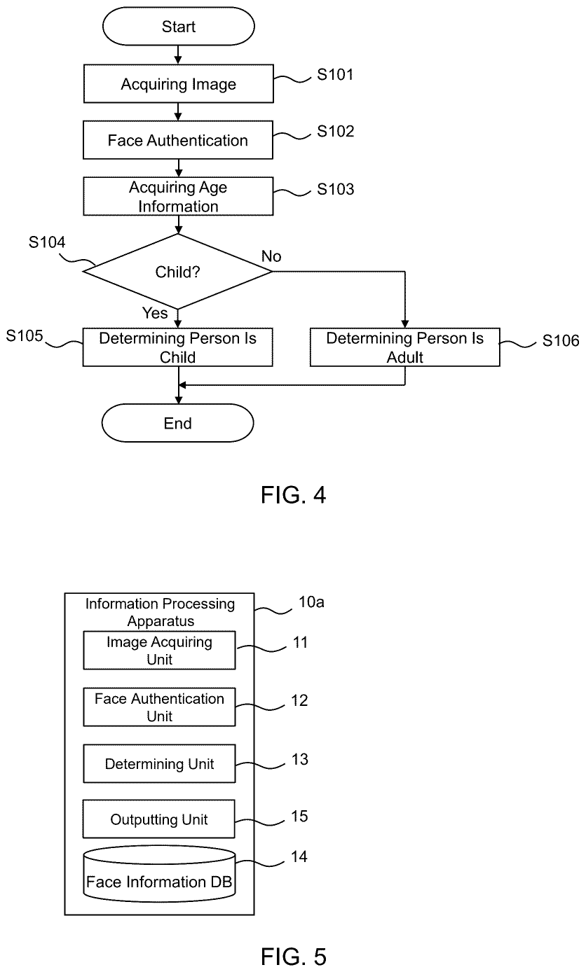

Next, the operation of the information processing apparatus 10 will be explained with reference to the flowchart in FIG. 4. In FIG. 4, the image acquiring unit 11 of the information processing apparatus 10 acquires an image (i.e., an image including a face authentication area) taken by a camera (e.g., at least one of cameras CAM 1 and CAM 2) (step S101).

The face authentication unit 12 performs face authentication based on the image acquired in the processing of the step S101 (step S102). The determining unit 13 acquires age information linked to the registered person corresponding to the authenticated person (i.e., the person included in the image acquired in the processing of step S101) identified in the processing of the step S102 (step S103).

The determining unit 13 determines whether or not the age of the authenticated person falls within the age range of children based on the age information acquired in the step S103 (step S104). When the age is determined to fall within the age range of children in the step S104 (step S104: Yes), the determining unit 13 determines that the authenticated person is a child (step S105). On the other hand, when the age is determined not to be that of a child in the step S104 (step S104: No), the determining unit 13 determines that the authenticated person is an adult (step S106).

In this way, in the information processing apparatus 10, an information processing method is performed, wherein the information processing method includes: acquiring an image including a face authentication area through which an authenticated person passes; performing face authentication of the authenticated person based on the image; and determining whether or not the authenticated person is a child by acquiring age information related to the authenticated person, which is linked to a registered person identified by performing the face authentication.

The information processing apparatus 10 described above may be realized by a computer reading a computer program recorded on a recording medium. In this case, it is can be said that the recording medium is a recording medium on which a computer program is recorded, wherein the computer program causes a computer to execute an information processing method including: acquiring an image including a face authentication area through which an authenticated person passes; performing face authentication of the authenticated person based on the image; and determining whether or not the authenticated person is a child by acquiring age information related to the authenticated person, which is linked to a registered person identified by performing the face authentication.

### Technical Effect

Railway fares are classified into “adult” and “child” categories. It is necessary to apply the appropriate fare to persons using the railway. For example, a technology has been proposed for estimating the age of a person from a face image showing the person's face. However, it is extremely difficult to accurately determine the age of a person from a face image showing the person's face.

In response to this, in the face information DB 14 provided by the information processing apparatus 10, age information is linked to the authentication ID of the registered person. For this reason, in the information processing apparatus 10, when the authenticated person (i.e., the person included in the image acquired by the image acquiring unit 11) is identified by the face authentication unit 12, the age of the authenticated person can be accurately identified based on the age information linked to the authentication ID related to the identified registered person. For this reason, according to the information processing apparatus 10, it is possible to accurately determine whether or not the authenticated person is a child. Therefore, according to the information processing apparatus 10, it is possible to apply appropriate fares to persons using the railway.

Incidentally, the classification of railway fares may include at least one of, for example, “infant” and “baby” in addition to ‘adult’ and “child.”

### First Modified Example

A first modified example of the first embodiment will be described with reference to FIG. 5. In the first modified example, the ticket gate system 1 may be provided with an information processing apparatus 10a instead of the information processing apparatus 10. In FIG. 5, the information processing apparatus 10a is provided with an image acquiring unit 11, a face authentication unit 12, a determining unit 13, a face information DB 14, and an output unit 15.

In the face information DB 14, time information indicating the date on which information relating to a registered person (e.g., at least one of face information, age information, and terminal information) is registered or updated may be linked to an authentication ID relating to a registered person. In this case, it can be said that the authentication ID, face information, age information, terminal information, and time information are linked to each other for a registered person.

When the determining unit 13 determines that the authenticated person is a child, the output unit 15 may acquire time information linked to the authentication ID related to the registered person corresponding to the authenticated person. The output unit 15 may calculate the difference between the date indicated by the acquired time information and the current date. The output unit 15 may determine whether the calculated difference is longer than a predetermined period (e.g., six months, one year, etc.).

When the calculated difference is determined to be longer than the predetermined period, the output unit 15 may output a notification prompting the updating of face information linked to the authentication ID associated with the registered person corresponding to the authenticated person. In this case, the output unit 15 may output the above notification to at least one of the terminal apparatus held by the authenticated person who has been determined to be a child and the terminal apparatus held by the guardian of the authenticated person, based on the terminal information linked to the authentication ID related to the registered person corresponding to the above authenticated person. When the calculated difference is determined to be shorter than the predetermined period, the output unit 15 may not output the above notification. When the calculated difference is “equal” to the predetermined period, it may be treated as either case.

### Technical Effect

The faces of persons of an age at which child fares apply for railway fares often change relatively quickly during the growth process. When the face information of persons of an age at which child fares apply registered in the face information DB 14 is not updated from the time of registration, it may become difficult to identify the above persons by face authentication after a certain period of time has elapsed from the time of registration (i.e., face authentication may fail).

In response to this, in the information processing apparatus 10a, when the determining unit 13 determines that the authenticated person is a child, and the difference between the date indicated by the above time information and the current date is longer than a predetermined period, the output unit 15 outputs a notification prompting the updating of face information. When the face information related to the authenticated person who has been determined to be a child is updated in accordance with the notification output from the output unit 15, the authenticated person can be identified by face authentication even if the face of the authenticated person has changed due to growth.

### Second Modified Example

A second modified example of the first embodiment is described with reference to FIG. 5. In the second modified example, the ticket gate system 1 may be provided with an information processing apparatus 10a instead of the information processing apparatus 10. In FIG. 5, the information processing apparatus 10a is provided with an image acquiring unit 11, a face authentication unit 12, a determining unit 13, a face information DB 14, and an output unit 15.

When the face authentication unit 12 performs face authentication and identifies a registered person corresponding to the authenticated person (for example, when the verification score for face authentication is greater than a predetermined threshold value) and the determining unit 13 determines that the authenticated person is a child, the output unit 15 may acquire the verification score for face authentication performed by the face authentication unit 12 for the authenticated person. The output unit 15 may determine whether the acquired match score is lower than a predetermined value. The predetermined value is, for example, a value higher than a predetermined threshold value for face authentication.

When the match score is determined to be lower than the predetermined value, the output unit 15 may output a notification prompting the updating of face information linked to the authentication ID of the registered person corresponding to the authenticated person. In this case, the output unit 15 may output the notification to at least one of the terminal device held by the authenticated person who has been determined to be a child and the terminal device held by the guardian of the authenticated person, based on the terminal information linked to the authentication ID related to the registered person corresponding to the authenticated person. When the comparison score is determined to be higher than the predetermined value, the output unit 15 may not output the notification. When the matching score is equal to the predetermined value, either case may be treated as a match.

### Technical Effect

The faces of persons of an age at which child fares apply for railway fares often change relatively quickly during the growth process. When the face information of persons of an age at which child fares apply registered in the face information DB 14 is not updated from the time of registration, it may become difficult to identify the above persons by face authentication after a certain period of time has elapsed from the time of registration (i.e., face authentication may fail).

When there is a difference between the face information registered in the face information database 14 and the actual face of a person of an age for which child fares apply (i.e., the face of the above person included in the image acquired by the image acquiring unit 11), the matching score for face authentication decreases.

In view of the above circumstances, in the information processing apparatus 10a, when the face authentication unit 12 performs face authentication, the registered person corresponding to the authenticated person is identified, and when the determining unit 13 determines that the authenticated person is a child, and the matching score for face authentication is lower than a predetermined value, the output unit 15 outputs a notification prompting the updating of face information. When the face information related to the authenticated person determined to be a child is updated in response to the notification output from the output unit 15, the authenticated person can be identified by face authentication even if the face of the authenticated person has changed due to growth.

Incidentally, the mode related to the second modified example may be combined with the mode related to the first modified example described above. In this case, when the verification score is determined to be lower than a predetermined value, and the difference between the date indicated by the time information linked to the authentication ID corresponding to the authenticated subject and the current date is determined to be longer than a predetermined period, the output unit 15 may output a notification prompting the updating of the face information linked to the authentication ID corresponding to the authenticated subject.

### Third Modified Example

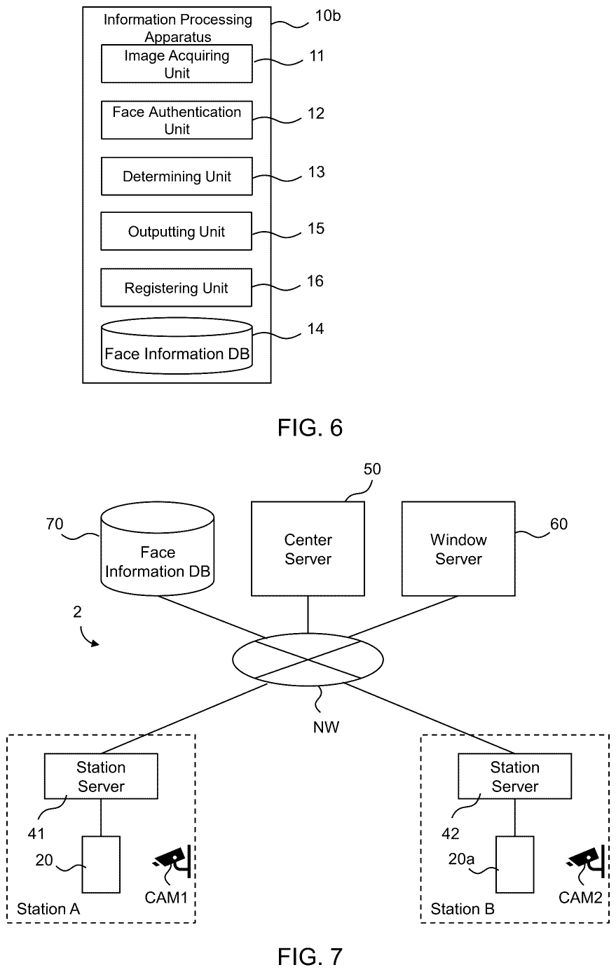

A third modified example of the first embodiment is described with reference to FIG. 6. In the third modified example, the ticket gate system 1 may be provided with an information processing apparatus 10b instead of the information processing apparatus 10. In FIG. 6, the information processing apparatus 10a is provided with an image acquiring unit 11, a face authentication unit 12, a determining unit 13, a face information DB 14, an output unit 15, and a registration unit 16. The information processing apparatus 10b may not be provided with the output unit 15.

The registration unit 16 may register information about new registered persons in the face information DB 14. The registration unit 16 may also modify (i.e., update) information about registered persons already registered in the face information DB 14.

The following describes in detail the method of acquisition by the registration unit 16 for acquiring a face image including the face of a single registered person. Here, a person who wishes to use the ticket gate system 1 (hereinafter referred to as an “applicant for use”) performs input operations using a terminal device (e.g., a smartphone) that he or she possesses. The registration unit 16 acquires, for example, a face image from the terminal device. Incidentally, when the information processing apparatus 10b has an input apparatus such as a touch panel, the applicant for use may perform the input operation using the input apparatus. The input operation may be performed by a representative of the applicant for use (e.g., a guardian) instead of or in addition to the user.

The registration unit 16 may acquire a face image including the face of the applicant for use, which is captured by a camera provided in the terminal device, from the terminal device. The registration unit 16 may register the acquired face image as face information of the applicant for use (i.e., a new registered person) in the face information DB 14 by linking it to an authentication ID related to the applicant for use. Alternatively, the registration unit 16 may calculate face feature quantities from the acquired face images. The registration unit 16 may register the calculated face feature quantities as face information of the applicant for use (i.e., the new registered person) in the face information DB 14 by linking them to the authentication ID related to the applicant for use.

A applicant for use may acquire a face image including the face of the applicant for use from a recording medium indicating the face of the applicant for use using a terminal device. For example, the applicant for use may acquire the face image by imaging a face image including the face of the applicant for use printed on the recording medium with a camera provided in the terminal device. For example, the applicant for use may obtain a face image by reading a face image including the face of the applicant for use stored in an electronic component (e.g., an IC chip) of the recording medium using a reading function (e.g., an IC card reader application) of the terminal device. My Number cards and driver's licenses are cited as examples of such recording media.

The registration unit 16 may acquire the face image acquired by the terminal device from the recording medium. The registration unit 16 may register the acquired face image in the face information DB 14 as face information of the applicant for use (i.e., a new registered person) linked to the authentication ID related to the user. Alternatively, the registration unit 16 may calculate the feature quantity from the acquired face image. The registration unit 16 may register the calculated face feature quantities as face information of the applicant for use (i.e., a new registered person) in the face information DB 14 by linking them to the authentication ID related to the applicant for use.

The face image acquired by the terminal device from the recording medium may be provided with acquisition route information indicating that it was acquired from the recording medium. The registration unit 16 may determine whether the acquired face image was acquired from the recording medium based on the acquisition path information.

When the registration unit 16 acquires a face image that the terminal device has acquired from the recording medium as a face image, the registration unit 16 may request the applicant for use to provide a face image including the current face of the applicant for use (i.e., actual face). The face image including the current face of the applicant for use may be captured by a camera of a terminal device held by the applicant for use. The registration unit 16 may request a face image including the current face (i.e., the actual face) of the applicant for use only when the current age of the user based on, for example, the date of birth of the user corresponds to the age to which the child fare for railway usage applies.

When the registration unit 16 acquires a face image including the current face of the applicant for use, the registration unit 16 may, for example, determine the degree of match between the face of the user indicated by the face image acquired by the terminal device from the recording medium and the current face of the applicant for use. Various existing methods may be used to determine the degree of match, but one example is a method of calculating a match score, such as the face authentication performed by the face authentication unit 12 (in this case, the match score corresponds to an indicator of the degree of match).

The registration unit 16 may determine whether the above degree of match is less than a predetermined degree. When the degree of matching is determined to be less than a predetermined degree, the registration unit 16 may acquire a face image including the current face of the user as a face image to be registered in the face information DB 14 as face information, in place of the face image acquired by the terminal apparatus from the recording medium (in other words, the face image acquired by the terminal apparatus from the recording medium is discarded). Alternatively, in this case, the registration unit 16 may register the face feature quantity calculated from the face image including the current face of the user as face information in the face information DB 14.

When the degree of the above match is determined to be greater than a predetermined degree, the registration unit 16 may acquire the face image acquired by the terminal device from the recording medium as a face image to be registered as face information in the face information DB 14. Alternatively, in this case, the registration unit 16 may register the face feature quantity calculated from the face image acquired by the terminal device from the recording medium as face information in the face information DB 14. In this case, the registration unit 16 may acquire both the face image acquired by the terminal device from the recording medium and the face image including the current face of the user as face information to be registered in the face information DB 14. When the degree of matching is “equal” to the predetermined degree, either case may be treated as included.

### Technical Effect

The faces of persons of an age at which child fares apply for railway fares often change relatively quickly during the growth process. When a face image including the face of a person of an age at which child fares apply as a applicant for use is acquired from the recording medium described above, there is a possibility that the face of the person indicated by the recording medium and the current face of the person may have changed to an extent that they are not determined to be the same person, for example, in face authentication.

As described above, when the degree of match between the face of the applicant for use indicated by the face image acquired by the terminal apparatus from the recording medium and the current face of the applicant for use is less than a predetermined degree, the registration unit 16 may acquire a face image including the current face of the applicant for use as a face image to be registered as face information in the face information DB 14 in place of the face image acquired by the terminal apparatus from the recording medium. Alternatively, in this case, the registration unit 16 may register the face feature quantity calculated from the face image including the current face of the applicant for use as face information in the face information DB 14. With this configuration, it is possible to appropriately register in the face information DB 14 face information relating to persons of an age to whom child fares apply, whose faces tend to change relatively quickly during the growth process.

### Second Embodiment

A second embodiment of an information processing apparatus, an information processing method, and a recording medium will be described with reference to FIGS. 7 to 10. Hereinafter, the second embodiment of the information processing apparatus, the information processing method, and the recording medium will be described by using an information processing apparatus 20 provided in the ticket gate system 2. In the second embodiment, explanations that overlap with the above description of the first embodiment are omitted as appropriate.

### Overview of the Ticket Gate System

An overview of the ticket gate system 2 according to the second embodiment will be described with reference to FIG. 7. In FIG. 7, the ticket gate system 2 comprises an information processing apparatus 20, a station server 41, and a camera CAM1 installed at the station A, an information processing apparatus 20a, a station server 42, and a camera CAM2 installed at the station B, a center server 50, a ticket window server 60, and a face information database 70 (hereinafter referred to as “face information DB 70” as appropriate). In addition to the information processing apparatus 20, other information processing apparatus may be installed at the station A. In other words, a plurality of information processing apparatus may be installed at the station A. Similarly, in addition to the information processing apparatus 20a, other information processing apparatus may be installed at the station B. In other words, a plurality of information processing apparatus may be installed at the station B.

At the station A, the information processing device 20 and the station server 41 may be connected via a local area network (LAN) or the like. Similarly, at the station B, the information processing device 20a and the station server 42 may be connected via a local area network. The station servers 41 and 42, the center server 50, the window server 60, and the face information DB 70 are connected via the network NW.

The information processing apparatus 20 may perform face authentication based on images captured by the camera CAM1 to identify persons entering the station A and persons exiting from the station A. The information processing apparatus 20 links identification information (e.g., authentication ID) indicating a registered person corresponding to a person identified by face authentication with information indicating that the person has entered the station A or information indicating that the person has exited from the station A, and transmits the linked information to the station server 41. The station server 41 transmits the information transmitted from the information processing apparatus 20 (i.e., identification information indicating the registered person corresponding to the person identified by face authentication, and information indicating that the person has entered the station A or information indicating that the person has exited from the station A) to the center server 50 at a predetermined communication cycle.

The information processing apparatus 20a may perform face authentication based on the image captured by the camera CAM2 and identify persons entering the station B and persons exiting from the station B. The information processing apparatus 20a links identification information (e.g., authentication ID) indicating the registered person corresponding to the person identified by face authentication with information indicating that the person has entered the station B or information indicating that the person has exited from the station B, and transmits the linked information to the station server 42. The station server 42 transmits the information transmitted from the information processing apparatus 20a (i.e., identification information indicating the registered person corresponding to the person identified by face authentication, and information indicating that the person has entered the station B or information indicating that the person has exited from the station B) to the center server 50 at a predetermined communication cycle.

The window server 60 is an apparatus that performs advance registration processing that must be performed by a person who wishes to use the ticket gate system 2 (hereinafter referred to as a “applicant for use”) before using the ticket gate system 2. In addition to advance registration processing, the window server 60 may perform information change processing to change the registration information of a person who is already using the ticket gate system 2.

The applicant for use may perform the pre-registration process by accessing the window server 60 using a terminal device (e.g., a smartphone) that he or she possesses. In the pre-registration process, the applicant for use may input, for example, his or her name, date of birth, telephone number, e-mail address, payment information, and face image.

The window server 60 may send information entered by the applicant for use during the advance registration process, such as name, date of birth, telephone number, email address, and payment information, to the center server 50, linking it to identification information (e.g., authentication ID) related to the applicant for use (i.e., the new registered person). The front office server 60 may link the information entered by the applicant for use during the pre-registration process, such as date of birth, telephone number, email address, and face image, to identification information (e.g., authentication ID) related to the applicant for use (i.e., new registered person) and newly register it in the face information DB 70.

Incidentally, the identification information of the applicant for use (i.e., the new registered person) sent from the window server 60 to the center server 50 may be the same as the identification information of the applicant for use (i.e., the new registered person) newly registered in the face information DB 70 by the window server 60. Incidentally, the identification information of the applicant for use (i.e., the new registered person) sent from the window server 60 to the center server 50 may be different from the identification information of the applicant for use (i.e., the new registered person) newly registered in the face information DB 70 by the window server 60. In this case, information for identifying the correspondence between the two may be generated.

Incidentally, the face information DB 70 may have the same configuration as the face information DB 14 shown in FIG. 3. The “date of birth” corresponds to an example of the “age information” shown in FIG. 3. The “phone number” and the “email address” correspond to examples of the “terminal information” shown in FIG. 3. The “face image” corresponds to an example of the “face information” shown in FIG. 3.

In the pre-registration process, the applicant for use may automatically input information such as their name, date of birth, telephone number, email address, and face image by using their own terminal device to read their photo ID, such as their My Number card or driver's license.

The center server 50 may calculate the railway usage fees for each registered person based on information transmitted from each of the plurality of station servers, including the station servers 41 and 42 (e.g., identification information indicating the registered person identified by face authentication and information indicating entry into and exit from the station). The center server 50 may settle the railway usage fees for each registered person using the settlement information related to each registered person.

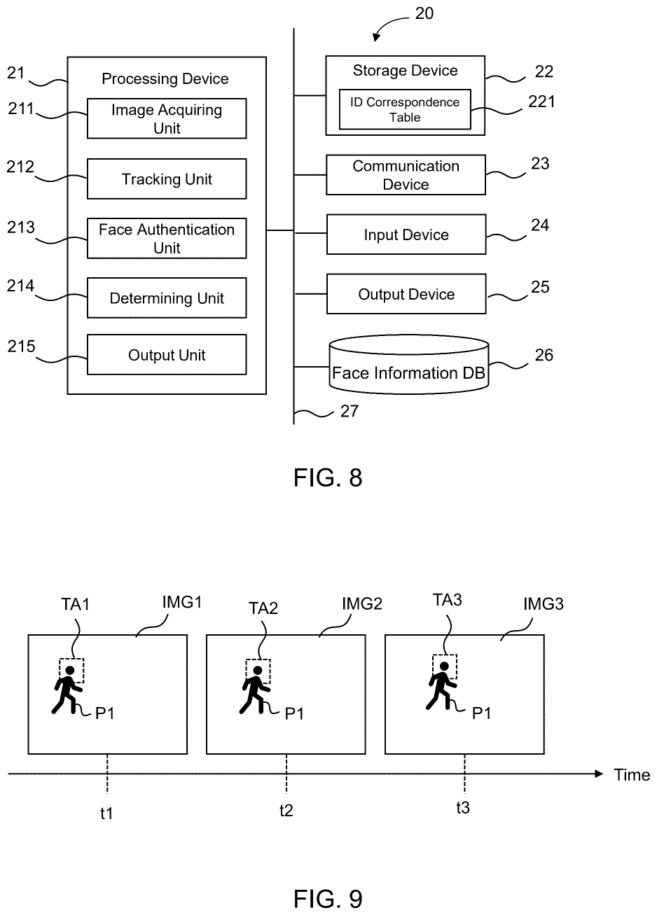

(Configuration of information processing apparatus) In FIG. 8, the information processing apparatus 20 is provided with an processing device 21, a storage device 22, and a communication device 23. The authentication apparatus 20 may further be provided with an input device 24 and an output device 25. The authentication apparatus 20 may be provided with a face information database 26 (hereinafter referred to as “face information DB 26” as appropriate). The information processing apparatus 20 may not necessarily include at least one of the input device 24 and the output device 25. In the information processing apparatus 20, the processing device 21, the storage device 22, the communication device 23, the input device 24, the output device 25, and the face information DB 26 may be connected via a data bus 27. Incidentally, the face information DB 26 may store the same information as that registered in the face information DB 70. The face information DB 26 may be updated at predetermined intervals to ensure that the information registered in the face information DB 26 is the same as that registered in the face information DB 70.

The processing device 21 may include at least one of a CPU (Central Processing Unit), a GPU (Graphics Processing Unit), an FPGA (Field Programmable Gate Array), a TPU (Tensor Processing Unit), and/or a quantum processor, for example.

The storage device 22 may include at least one of a RAM (Random Access Memory), a ROM (Read-Only Memory), a hard disk device, an optical magnetic disk device, an SSD (Solid State Drive), and optical disk arrays, for example. In other words, the storage device 22 may include non-transitory storage media. the storage device 22 can store desired data. For example, the storage device 22 may temporarily store computer programs executed by the processing device 21. The storage device 22 may temporarily store data that the processing device 21 temporarily uses when the processing device 21 executes a computer program.

The communication device 23 may be capable of communicating with devices external to the authentication apparatus 20. Incidentally, the communication device 23 may perform wired communication or wireless communication.

The input device 24 is a device capable of receiving information input from an external to the authentication apparatus 20. The input device 24 may include an operation device (e.g., a keyboard, mouse, touch panel, etc.) operable by an operator of the authentication apparatus 20. The input device 24 may include a recording medium reading device capable of reading information recorded on a recording medium removable from the authentication apparatus 20, such as a USB (Universal Serial Bus) memory. Furthermore, when information is input to the authentication apparatus 20 via the communication device 23 (in other words, when the authentication apparatus 20 acquires information via the communication device 23), the communication device 23 may function as an input device.

The output device 25 is a device capable of outputting information to the outside of the authentication apparatus 20. The output device 25 may output visual information such as characters or images as the above-mentioned information. The output device 25 may output auditory information such as voice as the above information. The output device 25 may output tactile information such as vibration as the above information. The output device 25 may include at least one of a display, a speaker, a printer, and a vibration motor. The output device 25 may be capable of outputting information to a recordable medium that is detachable from the authentication apparatus 20, such as a USB memory. Furthermore, when the authentication apparatus 20 outputs information via the communication device 23, the communication device 23 may function as an output device.

The processing device 21 may have an image acquiring unit 211, a tracking unit 212, a face authentication unit 213, a determining unit 214, and an output unit 215 as function blocks realized logically or as processing circuits realized physically.

Incidentally, at least one of the image acquiring unit 211, tracking unit 212, face authentication unit 213, determining unit 214, and output unit 215 may be realized in a form that mixes logical function blocks and physical processing circuits (i.e., hardware). When at least one of the image acquiring unit 211, the tracking unit 212, the face authentication unit 213, the determining unit 214, and the output unit 215 is a functional block, at least one of the image acquiring unit 211, the tracking unit 212, the face authentication unit 213, the determining unit 214, and the output unit 215 may be realized by the processing device 21 executing a predetermined computer program.

The processing device 21 may obtain (in other words, read) the predetermined computer program from the storage device 22. The processing device 21 may also read the predetermined computer program stored in a computer-readable and non-transitory recording medium by using a recording medium reading device not shown, which is provided in the authentication apparatus 20. The processing unit 21 may obtain (in other words, download or read) the predetermined computer program from an unillustrated device external to the authentication apparatus 20 via the communication device 23. Incidentally, at least one of an optical disc, a magnetic medium, a magneto-optical disc, a semiconductor memory, and any other medium capable of storing programs may be used as the recording medium for storing the predetermined computer program executed by the processing device 21.

The image acquiring unit 211, the face authentication unit 213, the determining unit 214, and the face information DB 26 are components corresponding to the image acquiring unit 11, the face authentication unit 12, the determining unit 13, and the face information DB 14 in the first embodiment described above. The “output unit 215” is a component corresponding to the “output unit 15” in at least one of the first modified example and the second modified example of the first embodiment described above.

The information processing apparatus 20a may have the same configuration as the information processing apparatus 20. Therefore, the explanation of the information processing apparatus 20a is omitted. The following describes the operation of the information processing apparatus 20, but the information processing apparatus 20a may perform the same operation as the information processing apparatus 20.

### Operation of Information Processing Apparatus

The information processing apparatus 20 performs face authentication of the authenticated person (e.g., at least one of the persons P1 and P2 in FIG. 2) based on the image captured by the camera CAM1. For example, the face authentication areas Ar1 and Ar2 shown in FIG. 2 are set in the ticket gate area of the station A. The information processing apparatus 20 may perform face authentication of the person P1 as the authenticated person while the person P1 is passing through the face authentication area Ar1 from outside the station A toward the station premises. The information processing apparatus 20 may perform face authentication of the person P2 as the authenticated person while the person P2 is passing through the face authentication area Ar2 from the station premises of the station A toward the suburbs.

In other words, the information processing apparatus 20 is an apparatus capable of performing walk-through face authentication. When no apparatus capable of physically preventing users from passing through the ticket gate area of the station A is provided, the face authentication method performed by the information processing apparatus 20 may be referred to as gate-less face authentication.

The image acquiring unit 211 acquires an image that includes at least a part of the face authentication area (e.g., at least one of the face authentication areas Ar1 and Ar2 shown in FIG. 2) set in the ticket gate area of the station A, which is taken by the camera CAM1. The camera CAM1 may be connected to the information processing apparatus 20 via a cable such as a USB cable. The camera CAM 1 may communicate with the information processing apparatus 20 by wireless communication such as Bluetooth (registered trademark). In these cases, the image acquiring unit 211 may directly acquire images from the camera CAM1. The camera CAM 1 may transmit the captured images to the station server 41. In this case, the image acquiring unit 211 may acquire images captured by the camera CAM1 from the station server 41.

The tracking unit 212 performs tracking processing of one or more persons passing through a face authentication area (e.g., at least one of the face authentication areas Ar1 and Ar2) using images acquired by the image acquiring unit 211 (e.g., images captured by the camera CAM1). In addition, the face authentication unit 213 performs face authentication processing of one or more persons passing through the face authentication area (e.g., at least one of the face authentication areas Ar1 and Ar2) using the image acquired by the image acquisition section 211.

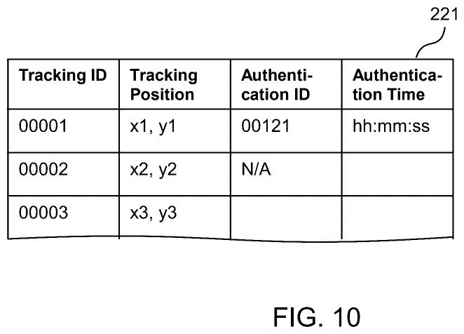

As a specific example of the tracking process performed by the tracking unit 212, a case, in which the tracking process is performed by the tracking unit 212 for the person P1 (see FIG. 2) passing through the face authentication area Ar1, will be described with reference to FIG. 9. In addition, as a specific example of the face authentication process performed by the face authentication unit 213, for a case, in which the face authentication process performed by the face authentication unit 213 for the person P1, will be described.

In FIG. 9, images IMG1, IMG2, and IMG3 are images that include the person P1 (in other words, images in which the person P1 is captured). The image IMG1 is an image generated by the camera CAM1 capturing the face authentication area Ar1 at time t1. The image IMG2 is an image generated by the camera CAM1 imaging the face authentication area Ar1 at time t2, which is later than time t1. The image IMG3 is an image generated by the camera CAM1 imaging the face authentication area Ar1 at time t3, which is later than time t2.

Images IMG1, IMG2, and IMG3 may each be images corresponding to one frame of a video. In this case, the image IMG2 need not be an image corresponding to the frame immediately following the frame corresponding to the image IMG1. In other words, the image IMG2 may be an image corresponding to a frame two or more frames later than the frame corresponding to the image IMG1. Similarly, the image IMG3 may not correspond to the frame immediately following the frame corresponding to the image IMG2. In other words, the image IMG3 may correspond to an image that is two or more frames later than the frame corresponding to the image IMG2.

The tracking unit 212 detects the head of the person P1 included in the image IMG1 from the image IMG1. Incidentally, the method for detecting a person's head from an image is based on existing technology, so details are omitted. The tracking unit 212 sets the area including the detected head of the person P1 as the tracking area TA1.

When the tracking unit 212 sets the tracking area TA1, it sets a tracking ID, which is identification information for identifying the person P1 associated with the tracking area TA1, for the person P1. The tracking unit 212 calculates the position of the person P1 (e.g., the position of the person P1's feet) based on the tracking area TA1. Since existing techniques can be applied to calculate the position of a subject included in an image from the image, a detailed description thereof is omitted. The tracking unit 212 links the tracking ID and the position of the person P1 to each other and registers them in an ID correspondence table 221 stored in the storage device 22.

When the tracking area TA1 is set, the tracking unit 212 determines whether or not the face of the person P1 is included in the tracking area TA1. In other words, the tracking unit 212 performs face detection with respect to the tracking area TA1. When it is determined that the face of the person P1 is captured in the tracking area TA1, tracking unit 212 generates a face image including the face area of the person P1. Tracking unit 212 links the generated face image with the tracking ID related to the person P1 and sends it to face authentication unit 213. When it is determined that the face of the person P1 is not captured in the tracking area TA1, the tracking unit 212 does not need to generate a face image.

The face authentication unit 213 performs face authentication processing using the face image sent from the tracking unit 212. For example, the face authentication unit 213 may calculate face feature quantities indicating features of the face of the person P1 from the above face image. The face authentication unit 213 may calculate a matching score from the calculated face feature quantity and the face feature quantity based on the face information of a registered person registered in the face information DB 26.

When the calculated matching score is greater than a predetermined threshold value, the face authentication unit 213 determines that face authentication was successful. In this case, a registered person corresponding to the person (here, the person P1) indicated by the face image transmitted from the tracking unit 212 is identified from among the plurality of registered persons registered in the face information DB 26. On the other hand, when the calculated matching score is smaller than the predetermined threshold value, the face authentication unit 213 determines that face authentication has failed. In this case, the person corresponding to the person (here, the person P1) indicated by the face image sent from the tracking unit 212 is likely not registered in the face information DB 26. Incidentally, if the calculated match score and the predetermined threshold are “equal,” either case may be treated as applicable.

When face authentication is successful, the face authentication unit 213 links the authentication ID indicating the registrant registered in the face information DB 26 corresponding to the person indicated by the face image transmitted from the tracking unit 212 (here, the person P1) to the tracking ID linked to the above face image, and registers it in the ID correspondence table 221. In addition to the authentication ID, the face authentication unit 213 may register the authentication time, which is the time when the face authentication process was performed, in the ID correspondence table 221. When face authentication fails, the face authentication unit 213 may register information indicating that there is no matching person (e.g., “N/A (Not Applicable)”) linked to the tracking ID linked to the face image sent from the tracking unit 212 in the ID correspondence table 221.

The ID correspondence table 221 will be described with reference to FIG. 10. As shown in FIG. 10, in the ID correspondence table 221, the tracking ID, the tracking position (e.g., the position of the feet of the person P1), the authentication ID, and the authentication time may be linked to each other. In the ID correspondence table 221, when the tracking ID is linked to a specific authentication ID, it indicates that a registered person corresponding to the person for whom the tracking ID is set is registered in the face information DB 26. When the tracking ID is linked to the character string “N/A,” this indicates that the person corresponding to the person for whom the tracking ID was set is not registered in the face information DB 26. When the tracking ID is not linked to an authentication ID (i.e., when the authentication ID field is blank), this indicates that face authentication has not been performed even once.

The tracking unit 212 may identify the person P1 contained in the image IMG2 using the image IMG2 and the image IMG1. Identifying the person P1 contained in the image IMG2 is equivalent to matching the person P1 contained in the image IMG1 with the person P1 contained in the image IMG2. Therefore, at least one of the matching method and the optical flow method related to image matching can be applied to identify the person P1 included in the image IMG2. Incidentally, various existing methods can be applied to each of the matching method and the optical flow method, so details are omitted.

When the person P1 included in the image IMG2 is identified, the tracking unit 212 detects the head of the person P1. The tracking unit 212 sets the area including the detected head of the person P1 as the tracking area TA2. Since the person P1 included in the image IMG1 and the person P1 included in the image IMG2 are the same person, the tracking ID of the person P1 associated with the tracking area TA2 is the same as the tracking ID of the person P1 associated with the tracking area TA1. The tracking unit 212 calculates the position of the person P1 based on the tracking area TA2.

The tracking unit 212 registers the position of the person P1 in the ID correspondence table 221 linked to the tracking ID associated with the person P1. In this case, since the position of the person P1 calculated based on the tracking area TA1 is already registered in ID correspondence table 221, when the tracking unit 212 registers the position of the person P1 calculated based on the tracking area TA2 in ID correspondence table 221, the position of the person P1 is updated.

When the tracking area TA2 is set, the tracking unit 212 determines whether or not the face of the person P1 is included in the tracking area TA2. In other words, the tracking unit 212 performs face detection for the tracking area TA2. When it is determined that the face of the person P1 is captured in the tracking area TA2, tracking unit 212 generates a face image including the face area of the person P1. The tracking unit 212 links the generated face image to the tracking ID related to the person P1 and sends it to the face authentication unit 213. When it is determined that the face of the person P1 is not captured in tracking area TA2, the tracking unit 212 does not need to generate a face image. Even if it is determined that the face of the person P1 is captured in the tracking area TA2, when the tracking ID related to the person P1 is linked to the authentication ID in the ID correspondence table 221 (i.e., when face authentication has already been successful), the tracking unit 212 does not need to generate a face image.

The face authentication unit 213 performs face authentication processing using the face image transmitted from the tracking unit 212. When face authentication is successful, the face authentication unit 213 links the authentication ID indicating the registrant registered in the face information DB 26 corresponding to the person (here, the person P1) indicated by the face image transmitted from the tracking unit 212 to the tracking ID linked to the above face image, and registers it in the ID correspondence table 221. In addition to the authentication ID, the face authentication unit 213 may register the authentication time, which is the time when the face authentication process was performed, in the ID correspondence table 221. When the authentication time is already registered in the ID correspondence table 221 (i.e., if face authentication has been successful in the past), the face authentication unit 213 may update the authentication time registered in the ID correspondence table 221. When face authentication fails, the face authentication unit 213 may register information indicating that there is no matching person (e.g., “N/A”) in the ID correspondence table 221 by linking it to the tracking ID linked to the face image sent from the tracking unit 212.

The tracking unit 212 may identify the person P1 included in the image IMG3 using the image IMG3 and the image IMG2. When the person P1 included in the image IMG3 is identified, the tracking unit 212 detects the head of the person P1. The tracking unit 212 sets the area including the head of the identified person P1 as the tracking area TA3 based on the detected head of the person P1. Since the person P1 included in the image IMG2 and the person P1 included in the image IMG3 are the same person, the tracking ID of the person P1 associated with the tracking area TA3 is the same as the tracking ID of the person P1 associated with the tracking area TA2. The tracking unit 212 calculates the position of the person P1 based on the tracking area TA3.

The tracking unit 212 registers the position of the person P1 in the ID correspondence table 221 linked to the tracking ID associated with the person P1. In this case, since the position of the person P1 calculated based on the tracking area TA2 is already registered in the ID correspondence table 221, registering the position of the person P1 calculated based on the tracking area TA3 in the ID correspondence table 221 updates the position of the person P1.

When the tracking area TA3 is set, the tracking unit 212 determines whether or not the face of the person P1 is included in the tracking area TA3. In other words, the tracking unit 212 performs face detection for the tracking area TA3. When it is determined that the face of the person P1 is captured in the tracking area TA3, the tracking unit 212 generates a face image including the face area of the person P1. The tracking unit 212 links the generated face image to the tracking ID related to the person P1 and sends it to the face authentication unit 213. When it is determined that the face of the person P1 is not present in the tracking area TA3, the tracking unit 212 does not need to generate a face image. Even if it is determined that the face of the person P1 is captured in the tracking area TA3, when the tracking ID related to the person P1 is linked to the authentication ID in the ID correspondence table 221 (i.e., when face authentication has already been successful), the tracking unit 212 does not need to generate a face image.

The face authentication unit 213 performs face authentication using the face image sent from the tracking unit 212. When face authentication is successful, the face authentication unit 213 registers the authentication ID indicating the registrant registered in the face information DB 26 corresponding to the person (in this case, the person P1) indicated by the face image transmitted from the tracking unit 212 to the tracking ID linked to the above face image in the ID correspondence table 221. In addition to the authentication ID, the face authentication unit 213 may register the authentication time, which is the time when the face authentication process was performed, in the ID correspondence table 221. When the authentication time is already registered in the ID correspondence table 221 (i.e., when face authentication has been successful in the past), the face authentication unit 213 may update the authentication time registered in the ID correspondence table 221. When face authentication fails, the face authentication unit 213 may register information indicating that there is no matching person (e.g., “N/A”) in the ID correspondence table 221 by linking it to the tracking ID linked to the face image sent from the tracking unit 212.

Incidentally, there are cases where the tracking unit 212 finds it difficult to continue tracking the person P1 due to the head of the person P1 being hidden by another person, etc. When tracking of the person P1 is lost, the tracking unit 212 may perform the following processing. The tracking unit 212 may determine whether or not a new person has been detected from the image acquired by the image acquiring unit 211 (e.g., the image captured by the camera CAM1) after the tracking of the person P1 is interrupted. The “new person” refers to a person for whom a tracking ID has not been set.

When a new person is detected, the tracking unit 212 may determine whether or not the person P1 and the new person are the same person by comparing the feature quantities of the tracking area related to the person P1 (e.g., at least one of the tracking areas TA1, TA2, and TA3) with the feature quantities of the tracking area related to the new person. When it is determined that the person P1 and the new person are the same person, the tracking unit 212 may set the tracking ID related to the person P1 for the new person. As a result, the tracking unit 212 can track the person P1 again. The feature quantity may be a feature quantity related to the head of a person, a feature quantity related to the upper body of a person, or a feature quantity related to the entire body of a person. In other words, the tracking area (e.g., at least one of tracking areas TA1, TA2, and TA3) may include the head of a person, the upper body of a person, or the entire body of a person. The feature quantity may be obtained, for example, by using person re-identification technology.

The tracking unit 212 and the face authentication unit 213 may repeat the above-described processing until the person P1 passes through the face authentication area Ar1. The tracking unit 212 and the face authentication unit 213 may perform the above-described processing for all persons who pass through the face authentication area Ar1.

The determining unit 214 acquires age information linked to the registered person corresponding to the authenticated person (e.g., the person P1) identified by the face authentication unit 213 based on the ID correspondence table 221 and the face information DB 26. The determining unit 214 determines whether or not the authenticated person is a child based on the acquired age information.

When the age information indicates the date of birth of the registrant corresponding to the authenticated person, the determining unit 214 may calculate the current age of the authenticated person from the date of birth indicated by the age information and the current date. The determining unit 214 may determine whether or not the authenticated person is a child based on the calculated age. When the age information indicates the current age of the registrant, the determining unit 214 may determine whether or not the authenticated person is a child based on the age indicated by the age information.

When the determining unit 214 determines that the authenticated person is a child, the information processing apparatus 20 may send to the center server 50, via the communication apparatus 23, the authentication ID corresponding to the authenticated person, information indicating that the authenticated person is a child, and information indicating that the authenticated person has entered the station A or has exited from the station A. The center server 50 may register that the registrant corresponding to the authentication ID transmitted from the information processing apparatus 20 is a child. When the determining unit 214 determines that the authenticated person is not a child (i.e., the authenticated person is an adult), the information processing apparatus 20 may send the authentication ID corresponding to the registered person associated with the authenticated person and information indicating that the authenticated person has entered the station A or has exited from the station A to the center server 50 via the communication apparatus 23. The center server 50 may register that the registrant corresponding to the authentication ID transmitted from the information processing apparatus 20 is an adult. The center server 50 need not register that the registrant is an adult. In this case, the center server 50 may treat registrants who are not registered as children as adults.

The information processing apparatus 20 may not transmit information indicating that the authenticated person is an adult to the center server 50. The information processing apparatus 20 may transmit information indicating that the authenticated person is an adult to the center server 50.

In the face information DB 26 (and face information DB 70), time information indicating the date on which information relating to a single registrant (e.g., at least one of face information, age information, and terminal information) was registered or updated may be linked to an authentication ID relating to a single registrant. In this case, it can be said that the authentication ID, face information, age information, terminal information, and time information are linked to each other for a single registrant.

When the determining unit 214 determines that the authenticated person is a child, the output unit 215 may obtain time information linked to the authentication ID of the registered person corresponding to the authenticated person from the face information DB 26. The output unit 215 may calculate the difference between the date indicated by the acquired time information and the current date. The output unit 215 may determine whether the calculated difference is longer than a predetermined period (e.g., six months, one year, etc.).

When the calculated difference is determined to be longer than the predetermined period, the output unit 215 may output a notification prompting the updating of face information linked to the authentication ID associated with the registered person corresponding to the above-mentioned authenticated person. In this case, the output unit 215 may output the notification to at least one of the terminal apparatus held by the authenticated person determined to be a child and the terminal apparatus held by the guardian of the authenticated person via the communication apparatus 23 based on the terminal information linked to the authentication ID related to the registered person corresponding to the above-mentioned authenticated person. Incidentally, when the calculated difference is determined to be shorter than a predetermined period, the output unit 215 may omit outputting the notification. Incidentally, when the calculated difference and the predetermined period are “equal,” either case may be treated as included.

When the face authentication unit 213 performs face authentication and identifies a registered person corresponding to the authenticated person (for example, when the face authentication match score is greater than a predetermined threshold value) and the determination unit 214 determines that the authenticated person is a child, the output unit 215 may acquire the match score obtained by the face authentication unit 213 for the face authentication performed on the authenticated person. The output unit 215 may determine whether the acquired match score is lower than a predetermined value. The predetermined value is, for example, a value higher than a predetermined threshold value for face authentication.

When the match score is determined to be lower than the predetermined value, the output unit 215 may output a notification prompting the updating of the face information linked to the authentication ID of the registered person corresponding to the authenticated person. In this case, the output unit 215 may transmit the notification via the communication apparatus 23 to at least one of the terminal apparatus held by the authenticated subject determined to be a child and the terminal apparatus held by the guardian of the authenticated subject, based on the terminal information linked to the authentication ID related to the registered person corresponding to the authenticated subject. Incidentally, when the matching score is determined to be higher than a predetermined value, the output unit 215 may omit outputting the notification. Incidentally, when the matching score and the predetermined value are “equal,” either

### Operation of the Window Server

As described above, the window server 60 performs the advance registration process. As described above, in the advance registration process, the applicant for use may automatically input, for example, their name, date of birth, telephone number, email address, and facial image by using a terminal device they possess to read, for example, their My Number card or driver's license with a facial photograph.

In the pre-registration process, when a face image is automatically entered by a user reading an ID card using a terminal device, the face image may be provided with acquisition path information indicating that it was read from the ID card. The window server 60 may determine whether the face image entered in the pre-registration process is a face image read from the ID card based on the acquisition path information.

When the face image entered in the pre-registration process is determined to be the face image read from the ID card, the window server 60 may request the applicant for use to provide a face image including the current face (i.e., actual face) of the applicant for use. The face image including the current face of the applicant for use may be captured by a camera provided in the terminal device held by the applicant for use. Furthermore, the window server 60 may request a facial image including the current face (i.e., the actual face) of the applicant for use only when the current age of the applicant for use, based on the date of birth entered during the pre-registration process, corresponds to the age at which the child fare applies for railway fares.

When the window server 60 obtains a facial image including the current face of the applicant for use, the window server 60 may determine the degree of similarity between the face of the applicant for use shown in the facial image read from the ID card and the current face of the applicant for use. Various existing methods may be used to determine the degree of match, but one example is a method of calculating a match score, such as the face authentication performed by the face authentication unit 213 (in this case, the match score corresponds to an indicator of the degree of match).

The ticket window server 60 may determine whether the above degree of match is less than a predetermined degree. When the degree of match is determined to be less than a predetermined degree, the window server 60 may acquire a face image including the current face of the applicant for use as a face image to be registered as face information in the face information DB 70, replacing the face image read from the ID card (in other words, discarding the face image read from the ID card). Alternatively, in this case, the window server 60 may register the face feature quantity calculated from the face image including the current face of the user as face information in the face information DB 70.

When the degree of the above match is determined to be greater than a predetermined degree, the window server 60 may acquire the face image read from the ID card as a face image to be registered as face information in the face information DB 70. Alternatively, in this case, the window server 60 may register the face feature quantity calculated from the face image read from the ID card as face information in the face information DB 70. In this case, the window server 60 may acquire both the face image read from the ID card and the face image including the current face of the applicant for use as face images to be registered as face information in the face information DB 70. When the degree of match is “equal” to the predetermined degree, either case may be included in the treatment.

### Technical Effect

According to the ticket gate system 2, as in the ticket gate system 1 including the information processing apparatus 10 of the first embodiment described above, it is possible to accurately determine whether or not the authenticated person is a child. Therefore, according to the ticket gate system 2, it is possible to apply appropriate fares to persons using the railway. In addition, when the face information related to the authenticated person who has been determined to be a child is updated in accordance with the notification output from the output unit 215, the authenticated person can be identified by face authentication even when the face of the authenticated person has changed due to growth.

As described above, during the pre-registration process, when the degree of similarity between the face of the user as shown in the face image read from the ID card and the current face of the user is less than a predetermined degree, the window server 60 may acquire the face image including the current face of the user as the face image to be registered as face information in the face information DB 70, instead of the face image read from the ID card. Alternatively, in this case, the window server 60 may register the face feature quantity calculated from the face image including the current face of the applicant for use as face information in the face information DB 70. With this configuration, face information relating to persons of an age to which child fares apply, whose faces tend to change relatively quickly during the growth process, can be appropriately registered in the face information DB 70.

### Supplementary Note

In regard to embodiments described above, the following supplementary notes will be further disclosed.

### Supplementary Note 1

An information processing apparatus comprising:
an image acquiring means for acquiring an image including a face authentication area through which an authenticated person passes;
a face authentication means for performing face authentication of the authenticated person based on the image; and
a determining means for determining whether or not the authenticated person is a child by acquiring age information related to the authenticated person, which is linked to a registered person identified by the face authentication means performing the face authentication.

### Supplementary Note 2

The information processing apparatus according to the supplementary note 1, wherein
the age information indicates a date of birth of the authenticated person, and
the determining means determines whether or not the authenticated person is a child based on the date of birth of the authenticated person and the current date.

### Supplementary Note 3

The information processing apparatus according to the supplementary note 1 or 2, wherein
the age information is linked to time information indicating a date on which the age information was registered, and
the information processing apparatus comprises an outputting means for outputting a notification prompting updating of face information related to a face linked to the registered person corresponding to the authenticated person when the determining means determines the authenticated person is a child, and when a difference between the date indicated by the time information and the current date is longer than a predetermined period.

### Supplementary Note 4

The information processing apparatus according to any one of supplementary notes 1 to 3, wherein
the information processing apparatus comprises an outputting means for outputting a notification prompting updating of face information related to a face linked to the registered person corresponding to the authenticated person when the registered person corresponds to the authenticated person is identified by the face authentication means performing the face authentication, and when the determining means determines the authenticated person is a child, and when a score of the face authentication is lower than a predetermined value.

### Supplementary Note 5

The information processing apparatus according to any one of supplementary notes 1 to 4, wherein
the face authentication means performs the face authentication based on first face information, which is face information relating to a face of the authenticated person acquired from the image, and second face information, which is face information relating to a face of the registered person and is linked to the registered person, and
the second face information is generated based on a recording medium showing the face of the registered person.

### Supplementary Note 6

The information processing apparatus according to any one of supplementary notes 1 to 5, wherein
the information processing apparatus comprises a registering means for registering registered person information relating to a registered person,
the registering means registers a face image including a face of the registered person as a part of the registered person information,
the registering means acquires the face image from a recording medium indicating the face of the registered person, and
the registering means acquires the face image from a captured image instead of the recording medium when a degree of matching between the face indicated by the recording medium and a face indicated by the captured image generated by imaging a current face of the registered person is less than a predetermined degree.

### Supplementary Note 7

An information processing method including:
acquiring an image including a face authentication area through which an authenticated person passes;
performing face authentication of the authenticated person based on the image; and
determining whether or not the authenticated person is a child by acquiring age information related to the authenticated person, which is linked to a registered person identified by performing the face authentication.

### Supplementary Note 8

A recording medium on which a computer program is recorded, wherein the computer program causes a computer to execute an information processing method including: acquiring an image including a face authentication area through which an authenticated person passes; performing face authentication of the authenticated person based on the image; and determining whether or not the authenticated person is a child by acquiring age information related to the authenticated person, which is linked to a registered person identified by performing the face authentication.

This disclosure may be changed as appropriate within the scope that does not contradict the essence or idea of the invention as read from the claims and the entire description. An information processing apparatus, an information processing method, and a recording medium with such changes are also included in the technical idea of this disclosure.

### EXPLANATION OF SYMBOLS

1,2 Ticket gate system
10, 10a, 10b, 20, 20a Information processing apparatus
11, 211 Image acquiring unit
12, 213 Face authentication unit
13, 214 Determining unit
14, 26, 70 Face information database
15, 215 Output unit
16 Registration unit
212 Tracking unit

What is claimed is:

1. An information processing apparatus comprising:
at least one memory configured to store instructions; and
at least one processor configured to execute the instructions to:
acquire an image including a face authentication area through which an authenticated person passes;
perform face authentication of the authenticated person based on the image; and
determine whether or not the authenticated person is a child by acquiring age information related to the authenticated person, which is linked to a registered person identified by means performing the face authentication,
wherein
the age information is linked to time information indicating a date on which the age information was registered, and
the at least one processor is configured to execute the instructions to output a notification prompting updating of face information related to a face linked to the registered person corresponding to the authenticated person when it is determined that the authenticated person is a child, and when a difference between the date indicated by the time information and the current date is longer than a predetermined period.

2. The information processing apparatus according to claim 1, wherein
the age information indicates a date of birth of the authenticated person, and
the at least one processor is configured to execute the instructions to determine whether or not the authenticated person is a child based on the date of birth of the authenticated person and the current date.

3. (Canceled)

4. The information processing apparatus according to claim 1, wherein
the at least one processor is configured to execute the instructions to output a notification prompting updating of face information related to a face linked to the registered person corresponding to the authenticated person when the registered person corresponds to the authenticated person is identified by means performing the face authentication, and when it is determined that the authenticated person is a child, and when a score of the face authentication is lower than a predetermined value.

5. The information processing apparatus according to claim 1, wherein
the least one processor is configured to execute the instructions to perform the face authentication based on first face information, which is face information relating to a face of the authenticated person acquired from the image, and second face information, which is face information relating to a face of the registered person and is linked to the registered person, and
the second face information is generated based on a recording medium showing the face of the registered person.

6. The information processing apparatus according to claim 1, wherein
the at least one processor is configured to execute the instructions to register registered person information relating to a registered person,
register a face image including a face of the registered person as a part of the registered person information,
acquire the face image from a recording medium indicating the face of the registered person, and
acquire the face image from a captured image instead of the recording medium when a degree of matching between the face indicated by the recording medium and a face indicated by the captured image generated by imaging a current face of the registered person is less than a predetermined degree.

7. An information processing method including:
acquiring an image including a face authentication area through which an authenticated person passes;
performing face authentication of the authenticated person based on the image; and
determining whether or not the authenticated person is a child by acquiring age information related to the authenticated person, which is linked to a registered person identified by performing the face authentication, wherein the age information is linked to time information indicating a date on which the age information was registered, and outputting a notification prompting updating of face information related to a face linked to the registered person corresponding to the authenticated person when it is determined that the authenticated person is a child, and when a difference between the date indicated by the time information and the current date is longer than a predetermined period.

8. A non-transitory recording medium on which a computer program is recorded, wherein the computer program causes a computer to execute an information processing method including: acquiring an image including a face authentication area through which an authenticated person passes; performing face authentication of the authenticated person based on the image; and determining whether or not the authenticated person is a child by acquiring age information related to the authenticated person, which is linked to a registered person identified by performing the face authentication, wherein the age information is linked to time information indicating a date on which the age information was registered, and outputting a notification prompting updating of face information related to a face linked to the registered person corresponding to the authenticated person when it is determined that the authenticated person is a child, and when a difference between the date indicated by the time information and the current date is longer than a predetermined period.
